(19) United States
(12) Patent Application Publication
(10) Pub. No.: US 2010/0017516 A1
(43) Pub. Date: Jan. 21, 2010

(54) DEMAND-DRIVEN OPTIMIZATION AND BALANCING OF TRANSCODING RESOURCES

(75) Inventors: Carlton J. Sparrell, Marblehead, MA (US); Manoj Wagle, Bangalore (IN); Thomas M. Tirpak, Glenview, IL (US); Peter J. Armbruster, Chandler, AZ (US); Samuel D. Glazer, New York, NY (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/500,807

(22) Filed: Jul. 10, 2009

Related U.S. Application Data
(60) Provisional application No. 61/081,207, filed on Jul. 16, 2008.
(60) Provisional application No. 61/081,282, filed on Jul. 16, 2008.

(51) Int. Cl. G06F 15/16

(52) U.S. Cl. 709/226; 709/231; 707/10; 709/241; 706/46

(57) ABSTRACT

The present invention provides a system and method for optimizing delivery of a content item from a content distribution network to a display device, where the content distribution network includes transcoding resources to convert the content item from a first format to a second format. A computing device receives a request to deliver the content item to the display device. The system selects, from the transcoding resources, an optimized transcoding resource based on an evaluation of metadata that describes the content item, a preferred technique for transcoding the content item, a state of the content distribution network, a predicted behavior for the user, and metadata that describes the display device. The system reserves the selected transcoding resource, and delivers the content item to the display device on a media stream that utilizes the selected transcoding resource.

### RELATED APPLICATIONS

This application for letters patent relates to and claims the benefit of U.S. Provisional Patent Application Ser. No. 61/081,207 (Attorney's docket number BCS04891), titled “SYSTEM AND METHOD FOR BALANCING STORAGE AND TRANSCODING RESOURCES”, and filed on Jul. 16, 2008; the disclosure of which this application hereby incorporates by reference.

This application for letters patent also relates to and claims the benefit of U.S. Provisional Patent Application Ser. No. 61/081,282 (Attorney's docket number BCS04891), titled “DEMAND-DRIVEN OPTIMIZATION OF TRANSCODING POINT”, and filed on Jul. 16, 2008; the disclosure of which this application hereby incorporates by reference.

### BACKGROUND

Today, consumers can view video content on a large variety of display devices. These display devices typically support a small number of resolutions and formats. Accordingly, a content distribution network must be able to deliver the content in multiple formats for multiple devices and network bandwidths. Storing the content in every conceivable format is not efficient, neither is providing live transcoding resources to be able to transcode formats on the fly at all times.

Optimization of the transcoding process can be complex. Transcoders may be located in the network core or at the network edge. Transcoding may be performed each time content is viewed, or transcoding may be performed once (for each format) with the content cached in network or edge storage for use at a future time.

Deciding where and when to transcode typically involves an analysis of multiple factors. Considerations may include, for example, the cost and availability of network, edge and end user transcoders, the cost and availability of core, edge and access bandwidth, the viewing frequency of a particular content title and format, the cost and availability of caching storage, the end device capabilities (including display, processing, power, access bandwidth, etc.), and the predicted end user behavior (such as the likelihood that the user will watch this show to completion or change networks or devices soon, etc.)

### SUMMARY

Aspects of the present invention provide a system and method for optimizing delivery of a content item from a content distribution network to a display device. In one embodiment, the content distribution network includes transcoding resources, each transcoding resource converting the content item from a first format to a second format. The method receives a request at a computing device to deliver the content item to the display device. The method obtains metadata that describes the content item, a predicted behavior for a user when accessing the content item on the display device, and metadata that describes the display device. The method determines a preferred technique for transcoding the content item, and a state of the content distribution network. The method selects, from the transcoding resources, an optimized transcoding resource based on an evaluation of the metadata that describes the content item, the preferred technique for transcoding the content item, the state of the content distribution network, the predicted behavior for the user, and the metadata that describes the display device. The method reserves the selected transcoding resource, and delivers the content item to the display device on a media stream that utilizes the selected transcoding resource.

In another embodiment, the system uses distributed computing devices to optimize delivery of a content item from a content distribution network to a display device. The distributed computing devices in the system include request handlers, optimizers, and workflow engines. Each request handler receives a request to deliver the content item to the display device. Each optimizer obtains metadata that describes the content item, and metadata that describes the display device. Each optimizer also receives a preferred technique for transcoding the content item from a rules and policy engine in the distributed computers, a state of the content distribution network from a network admission control in the distributed computing devices, and a predicted behavior for a user when accessing the content item on the display device from a user behavior predictor in the distributed computers. Each optimizer selects, from the transcoding resources, an optimized transcoding resource based on an evaluation of the metadata that describes the content item, the preferred technique for transcoding the content item, the state of the content distribution network, the predicted behavior for the user, and the metadata that describes the display device. Each workflow engine reserves the selected transcoding resource, and delivers the content item to the display device on a media stream that utilizes the selected transcoding resource.

### BRIEF DESCRIPTION OF THE DRAWINGS

FIG. 1 is block diagram that illustrates one embodiment of the hardware components of a system that performs the present invention.

FIG. 2 is a block diagram that illustrates, in detail, one embodiment of the hardware components shown in FIG. 1.

FIG. 3 is a flow chart that illustrates a method for optimizing delivery of a content item from a content distribution network to a display device according to an embodiment of the present invention.

FIG. 4 is a flow chart that illustrates one embodiment of distributed, loosely synchronized aggregators in a content distribution network 120 according to an embodiment of the present invention.

### DETAILED DESCRIPTION

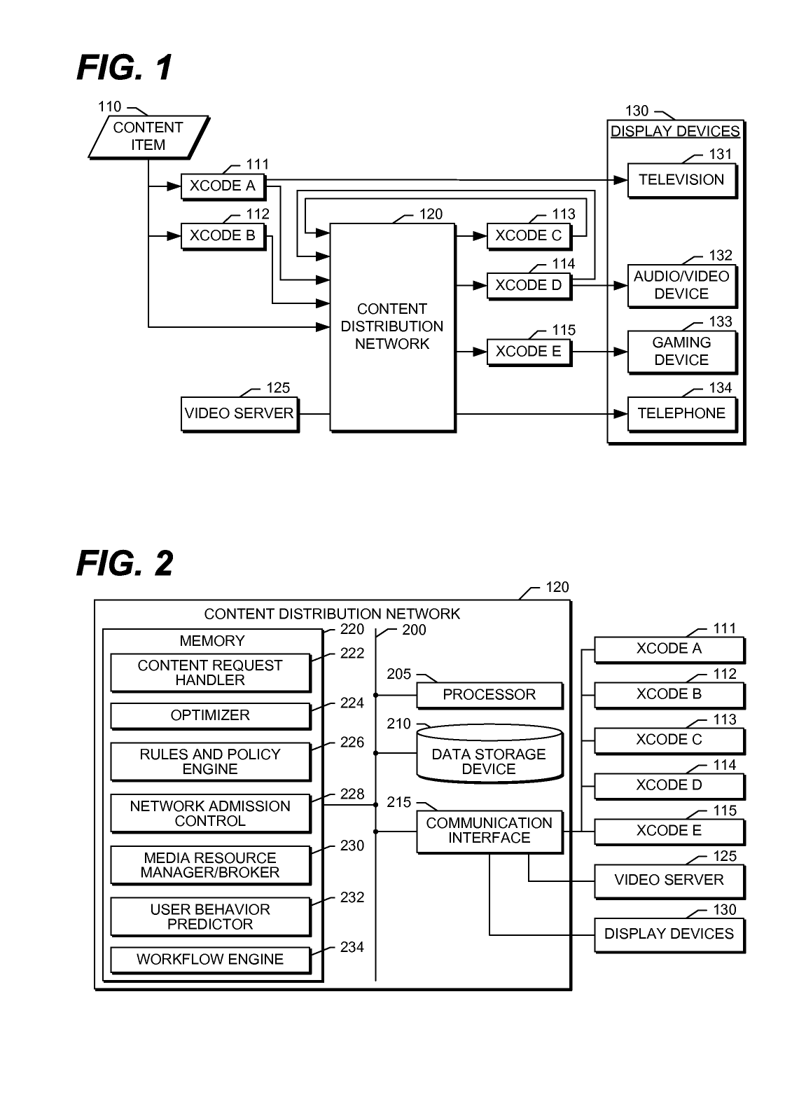

FIG. 1 is a block diagram that illustrates one embodiment of the hardware components of a system that performs the present invention. As shown in FIG. 1, content distribution network 120 receives a content item 110, stores the content item 110 on a video server 125, and delivers the content item 110 in different formats and resolutions to a variety of display devices 130. In another embodiment, the storing of the content item 110 on the video server 125 is optional. Illustrative applications of the content distribution network 120 include Set Top Boxes, Cable Head-End Systems, Video Production Systems, Internet Protocol Television (IP TV), and Mobile Video Streaming/Distribution. In one embodiment, the content item 110 is uncompressed. In another embodiment, the content item 110 is compressed at no or low loss in a high-resolution format. In one embodiment, transcoding resources (such as xcode A 111, xcode B 112, xcode C 113, xcode D 114, and xcode E 115) receive the content item 110 and deliver the transcoded content to the content distribution network 120. In another embodiment, the content distribution network 120 includes the transcoding resources (such as xcode A 111, xcode B 112, xcode C 113, xcode D 114, and xcode E 115) and receives the content item 110 directly. In various embodiments, the display devices 130 include a television 131, audio/video device 132, gaming device 133, and telephone 134.

The content distribution network 120 shown in FIG. 1, in an exemplary embodiment, is a public communication network that connects the transcoding resources and the video server 125 to the display devices 130 and facilitates distribution of content items 110 to the display devices 130. The present invention also contemplates the use of comparable network architectures. Comparable network architectures include the Public Switched Telephone Network (PSTN), a public packet-switched network carrying data and voice packets, a wireless network, and a private network. A wireless network includes a cellular network (e.g., a Time Division Multiple Access (TDMA), Code Division Multiple Access (CDMA), or Orthogonal Frequency Division Multiplexing (OFDM) network), a satellite network, and a wireless Local Area Network (LAN) (e.g., a wireless fidelity (Wi-Fi) network). A private network includes a LAN, a Personal Area Network (PAN) such as a Bluetooth network, a wireless LAN, a Virtual Private Network (VPN), an intranet, or an extranet. An intranet is a private communication network that provides an organization such as a corporation, with a secure means for trusted members of the organization to access the resources on the organization's network. In contrast, an extranet is a private communication network that provides an organization, such as a corporation, with a secure means for the organization to authorize non-members of the organization to access certain resources on the organization's network. The system also contemplates network architectures and protocols such as Ethernet, Token Ring, Systems Network Architecture, Internet Protocol, Transmission Control Protocol, User Datagram Protocol, Asynchronous Transfer Mode, and proprietary network protocols comparable to the Internet Protocol.

In one embodiment shown in FIG. 1, xcode A 111 receives the content item 110 as an encoded stream and delivers the content item 110 directly to one of the display devices 130, such as the television 131.

In another embodiment shown in FIG. 1, xcode A 111 and xcode B 112 each receive the content item 110 as a content stream in a first format, and deliver a transcoded content stream in a second format, to the content distribution network 120. The content distribution network 120 stores the transcoded content stream in one or more formats and resolutions for later access. In various embodiments, the content distribution network 120 stores the transcoded content in a memory device of the content distribution network 120, or in the streaming video server 125 (such as video-on-demand (VOD) or Video Streamer) connected to the content distribution network 120 via a network (not shown), wired connection, or wireless connection (not shown).

In another embodiment shown in FIG. 1, the content distribution network 120 may determine that it expects to need the stored content in another format. The content distribution network 120 retrieves the content item 110 stored in a first format, delivers the stored content to xcode C 113 for transcoding or transrating, receives transcoded or transrated content from xcode C 113 in a second format, and stores the transcoded or transrated content received from xcode C 113 for later access.

In another embodiment shown in FIG. 1, the content distribution network 120 may receive a request from one of the display devices 130, such as the audio/video device 132 or gaming device 133, for the stored content in another format. The content distribution network 120 retrieves the content item 110 stored in a first format, and delivers the stored content to the audio/video device 132 via xcode D 114 or xcode E 115 which transcodes or transrates the stored content to a second format. In one embodiment, if the content distribution network 120 determines that it expects to use the content in the new format in the future, xcode D 114 also sends the content in the second format back to the content distribution network 120 for storage.

FIG. 2 is a block diagram that illustrates, in detail, one embodiment of the hardware components shown in FIG. 1. In particular, FIG. 2 illustrates the hardware components and software comprising the content distribution network 120.

The content distribution network 120 shown in FIG. 2 is a general-purpose computing device that performs the present invention. A bus 200 is a communication medium that connects a processor 205, data storage device 210 (such as a disk drive, flash drive, flash memory, or the like), communication interface 215, and memory 220. The communication interface 215 transmits and receives the data between the content distribution network 120 and the video server 125, display devices 130, and transcoding resources (such as xcode A 111, xcode B 112, xcode C 113, xcode D 114, and xcode E 115).

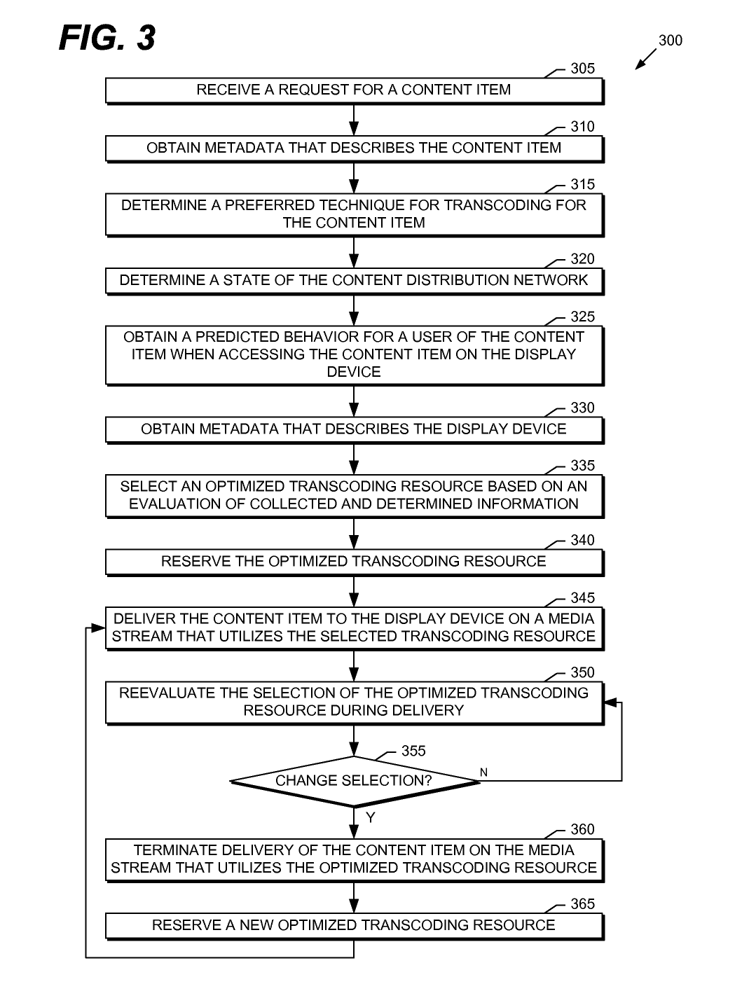

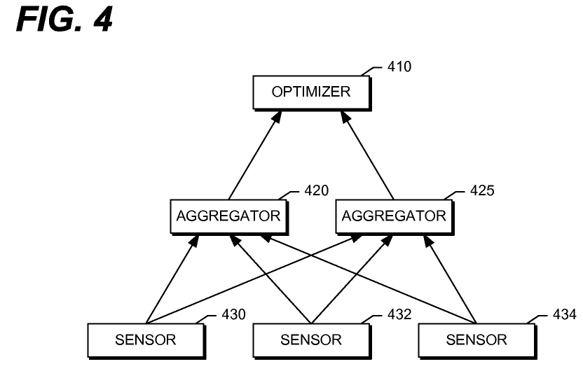

The processor 205 performs the disclosed methods by executing the sequences of operational instructions that comprise each computer program resident in, or operative on, the memory 220. The reader should understand that the memory 220 may include operating system, administrative, and database programs that support the programs disclosed in this application. In one embodiment, the configuration of the memory 220 of the content distribution network 120 includes a content request handler 222, optimizer 224, rules and policy engine 226, network admission control 228, media resource manager/broker 230, user behavior predictor 232, and workflow engine 234. The content request handler 222, optimizer 224, rules and policy engine 226, network admission control 228, media resource manager/broker 230, user behavior predictor 232, and workflow engine 234 perform the method of the present invention disclosed in detail in FIG. 3 and FIG. 4. These computer programs store intermediate results in the memory 220, or data storage device 210. In another embodiment, the memory 220 may swap these programs, or portions thereof, in and out of the memory 220 as needed, and thus may include fewer than all of these programs at any one time. In another embodiment, the optimizer 224, rules and policy engine 226, network admission control 228, media resource manager/broker 230, and user behavior predictor 232 are connected to the content distribution network 120 via a network (not shown), wired connection, or wireless connection (not shown).

FIG. 3 is a flow chart that illustrates a method for optimizing delivery of a content item 110 from a content distribution network 120 to a display device 130 according to an embodiment of the present invention. With reference to FIG. 1 and FIG. 2, the process 300 shown in FIG. 3 begins by receiving a request for a content item 110 (step 305). In one embodiment, the user identifies the content item 110 by title and sends the request from the display device 130 that will view the content item 110. In another embodiment, the user sends the request from a computing device other than the device that will view the content item 110. The content request handler 222 receives the request for content item 110 and forwards the request to the optimizer 224. The optimizer 224 determines which formats are created a priori (high demand) versus on the fly (low demand), as well as which formats are cached for future use. In one embodiment, the optimizer 224 can determine how long to keep various formats cached. In another embodiment, formats that are cached may be flushed after a predetermined period of non-use, e.g. 24 hours after the last time content was accessed in a specific format. In a further embodiment, transcoding into additional formats may be done at times of high availability of transcoding resources (load balancing).

The optimizer 224 obtains metadata that describes the content item 110 (step 310). In one embodiment, the optimizer 224 accesses a metadata repository to obtain current metadata for the content item 110 (i.e., information that describes the content item 110). The current metadata for the content item 110 includes a description of the content item 110 (e.g. running-time (i.e., duration or length), available formats or encodings, and display formats such as resolution and aspect ratios), policies that specify preferred and permitted transcoding techniques, and display device characteristics. The metadata repository also may return information about the popularity and topical nature of the content. In another embodiment, the content item 110 and the request for the content item 110 include tags that provide the current metadata for the content item 110 to the optimizer 224.

The optimizer 224 determines a preferred technique for transcoding the content item 110 (step 315). In one embodiment, the optimizer 224 accesses a rules and policy engine 226 to determine the preferred technique for transcoding the content item 110. This helps the optimizer 224 to determine whether the content item 110 should be cached because it is a top-rated show and will likely be viewed many times on all types of devices, or should not be cached because it is content of interest to only a small number of users; for example, that the content item 110 is not often viewed on devices with these display characteristics.

In addition, it is contemplated that in some embodiments, content owners may restrict the availability of content to a specific set of formats. For example, a content owner may elect not to allow content or advertising created in high-definition (HD) to be delivered to a mobile phone with a 2-inch screen, or the content owner may restrict viewing in certain locations.

The optimizer 224 determines a state of the content distribution network 120 (step 320). In one embodiment, the optimizer 224 accesses network admission control 228 and media resource manager/broker 230 to determine the state of the content distribution network 120. In one embodiment, to determine the state the optimizer 224 analyzes the content distribution network 120 to determine traffic congestion (i.e., whether certain nodes are congested and traffic should be routed around these locations) and bandwidth availability (i.e., whether certain nodes are available and available bandwidth for those nodes) for the content distribution network 120, and an estimated cost for using the transcoding resources (such as xcode A 111, xcode B 112, xcode C 113, xcode D 114, and xcode E 115) to transcoded the content item.

The optimizer 224 obtains a predicted behavior for a user of the content item 110 when accessing the content item 110 on the display device 130 (step 325). In one embodiment, the optimizer 224 access user behavior predictor 232 to obtain the predicted behavior for the user of the content item 110 when accessing the content item 110 on the display device 130. The user behavior predictor 232 receives input such as usage history, content type (sports, movie, etc), codec (MPEG_{—}2, MPEG_{—}4, 3GPP, etc), resolution (HD-1080p, SDTV, QCIF, etc.), available bandwidth, expected popularity, quality of service (QOS), etc. This will attempt to predict the user's behavior while viewing the content item 110. If the user is likely to watch only a segment of the content item 110, the entire content item 110 will not be made available to cache. If the user is likely to change devices while watching the content item 110, there may be a need to change the transcoding resource. The user behavior predictor 232 makes its predictions based on the user's profile (i.e., information the user has provided), the user's past behavior, and the past behavior of other users (such as typical behavior for all users, or typical behavior for similar users).

The optimizer 224 obtains metadata that describes the display device 130 (i.e., information that describes the display device 130) that will be used to display (or play) the content item 110. In one embodiment, the optimizer 224 accesses a metadata repository to obtain current metadata for the display device 130. In another embodiment, the optimizer 224 receives the current metadata from the display device 130. This information includes device capabilities such as screen resolution, available computing resources (such as the ability to process certain codecs, current location, battery life, power required to run different codecs), availability of access bandwidth including information about the access network being used and other networks that are available. In another embodiment, the content item 110 and the request for the content item 110 include tags that provide the information that describes the display device 130 to the optimizer 224.

The optimizer 224 selects from the transcoding resources an optimized transcoding resource based on an evaluation of the collected and determined information (step 335). In one embodiment, the collected and determined information includes the metadata that describes the content item, the preferred technique for transcoding the content item, the state of the content distribution network, the predicted behavior for the user, and the metadata that describes the display device. The optimizer 224 communicates an optimized transcoding technique and the selected resource to the workflow engine 234 that reserves the selected transcoding resource (using the network admission control 228 and the media server resource manager/broker 230) (step 340). The workflow engine 234 then delivers the content item 110 to the display device 130 on a media stream that utilizes the selected transcoding resource (step 345).

While the workflow engine 234 is delivering/playing the media stream, the optimizer 224 may continually or periodically reevaluate the selection of the optimized transcoding resource during delivery (step 350). If the reevaluating determines that a change to the selected optimized transcoding resource is not necessary (step 355, “N” branch), the optimizer 224 will continue to periodically reevaluate the selection of the selected optimized transcoding resource (step 350). If the reevaluating determines that a change to the selected optimized transcoding resource is necessary (step 355, “Y” branch), the optimizer 224 will invoke the workflow engine 234 to terminate the delivery of the content item 110 on the media stream that utilizes the previously optimized transcoding resource (step 360), reserves a new optimized transcoding resource (using the network admission control 228 and the media server resource manager/broker 230) (step 365), and delivers the content item 110 to the display device 130 on a new media stream that utilizes the new optimized transcoding resource (step 345). This will involve communicating with the display device 130 to initiate a seamless transition where the user has little awareness of the change. This can be performed as long as the jitter buffer in the device is already adequately large (or can be enlarged on instructions from the workflow engine). In one embodiment, the optimizer 224 may monitor messages communicated by the display device 130 to the media server 230 explicitly requesting an adjustment of the encoding scheme; the optimizer 224 subsequently accounts for these requests in its selection or reevaluation of the optimized transcoding resources. The optimizer 224 may receive such explicit requests in operating scenarios, such as the following: A client is downloading a 4 Mbps video over a link, and the bandwidth on this link drops to 3 Mbps. As a result, the decoder will run out of video frames, which would cause the video to stutter. Accordingly, the client issues a request for 2 Mbps video so that pausing playback is not required.

FIG. 4 is a flow chart that illustrates one embodiment of distributed, loosely synchronized aggregator computer processes in a content distribution network 120 according to an embodiment of the present invention. A network (not shown) connected to the content distribution network 120 may include a plurality of content request handlers 222, optimizers 224, rules and policy engines 226, network admission controllers 228, media resource managers/brokers 230, and user behavior predictors 232. Each of these network-based elements may act as an aggregator 420 to aggregate and synchronize the updates from the other network-based elements. As shown in FIG. 4, with reference to FIG. 1 and FIG. 2, the requesting display device 130 may send its request to one of several content request handlers 222, which in turn may rely on one of many optimizers 224, etc. To loosely synchronize the optimizers 224 and other elements, each sensor 430, 432, 434 sends updates to all aggregators 420, 425. Since each aggregator 420, 425 receives the same state update information, each aggregator 420, 425 has access to the same state information. There may be small differences based on timing, lost updates, retransmissions, etc. However, these differences will not be significant, since the goal of the optimizer is not to make perfect decisions, but rather to efficiently identify good solutions in a timely manner. In other words, it is trying to identify solutions that statistically minimize costs (and maximize quality). It is the job of the workflow manager to perform precise allocation of resources.

The following illustrative use cases refer to a network for a content distribution network 120 that involves the following types of entities, whose overall flow is from “Content Creators” to “Content Aggregators”, to “Regional Gateways” to “Home (Local) Gateways”, and to “Personal Devices”.

Illustrative Use Case 1

TV Show “XYZ Smiletime” is popular in Schaumburg. The broadcast version of “XYZ Smiletime” was a big hit in Chicagoland (a metropolitan area that includes Schaumburg). During or after the initial broadcast of this show, the Content Aggregator (e.g., cable network operator), tags the content with a popularity index. As this content is distributed/propagated throughout the network in this geographic area, the Regional Gateways automatically transcode and distribute to a wide variety of Personal Device formats used within the Home (Local) Gateways, and cache this content based on the anticipated demand. Alternatively, based on the observed (on anticipated) popularity of a given content item, content tags are inserted that instruct downstream entities to (a) transcode to a specific set of formats; (b) transcode to the N most popular formats; (c) transcode to the M most space-efficient formats; or (d) transcode to the P most bandwidth-efficient formats, if they can. Based on collected information about network configuration and resource loading, the tags target the transcoding to (a) a specific resource, if available; (b) the lowest-level entity, i.e., a Personal Device; (c) the highest-level entity; or combinations of these.

Illustrative Use Case 2

Content Best Viewed in MPEG-4. Content Producers can insert tags into content stating that it is best viewed in MPEG-4. Alternatively, actual viewer statistics and/or inventories provided by Home (Local) Gateways may indicate the greatest number of viewers prefer the MPEG-4 version of content. Subsequently, the content transcoding optimization directs the transcoding to the resource, along the distribution pathway, which has the best MPEG-4 encoder. The optimization also considers the transcoding workload assigned to the various resources, and prioritizes the transcoding according to the quality of the MPEG-4 result and the number of likely viewers beneath it in the content distribution network (tree).

Illustrative Use Case 3

Ready to Go When You Are. The Local (Home) Gateways collect statistics about the mobility and content usage patterns of users, and identify typical user profiles. Regional Gateways aggregate these statistics, and identify typical user profiles. For example: When Bob watches a show on cable TV, he typically wants to watch related content, and re-runs of the same content, on his Motorola Video Phone as he commutes to work by train. Content is transcoded in anticipation of using the content of Personal Devices in the future. The transcoding is done at the highest level in the distribution network at which there emerges a significant “typical user profile”. If the “user profile” is unique to a given Local (Home) Gateway, then the transcoding is done with the resources available within the home.

Although the disclosed embodiments describe a fully functioning method for optimizing delivery of a content item from a content distribution network to a display device, the reader should understand that other equivalent embodiments exist. Since numerous modifications and variations will occur to those reviewing this disclosure, the method for optimizing delivery of a content item from a content distribution network to a display device is not limited to the exact construction and operation illustrated and disclosed. Accordingly, this disclosure intends all suitable modifications and equivalents to fall within the scope of the claims.

We claim:

1. A method for using a computing device to optimize delivery of a content item from a content distribution network to a display device, wherein the content distribution network includes at least one transcoding resource, each transcoding resource converting the content item from a first format to a second format, comprising:
receiving a request at the computing device to deliver the content item to the display device;
obtaining metadata that describes the content item;
determining a preferred technique for transcoding the content item;
determining a state of the content distribution network;
obtaining a predicted behavior for a user when accessing the content item on the display device;
obtaining metadata that describes the display device;
selecting, from said at least one transcoding resource, an optimized transcoding resource, the selection based on an evaluation of:
the metadata that describes the content item,
the preferred technique for transcoding the content item,
the state of the content distribution network,
the predicted behavior for the user, and
the metadata that describes the display device;
reserving the selected transcoding resource; and
delivering the content item to the display device on a media stream that utilizes the selected transcoding resource.

2. The method of claim 1, wherein the obtaining of the metadata that describes the content item further comprises:
sending a request for the metadata that describes the content item to a metadata repository; and
receiving the metadata that describes the content item in response to the request for the metadata.

3. The method of claim 1, wherein the obtaining of the metadata that describes the content item further comprises:
retrieving the metadata that describes the content item from tag fields embedded in the content item.

4. The method of claim 1, wherein the metadata that describes the content item includes a duration for the content item, available display formats and encodings, and popularity and topical nature of the content item.

5. The method of claim 1, wherein the determining of the state further comprises:
analyzing traffic congestion and bandwidth availability for the content distribution network; and
obtaining an estimated cost for transcoding the content item with each transcoding resource that is available.

6. The method of claim 1, wherein the predicted behavior for the user is based on a profile for the user, past behavior for the user, and past behavior of other users.

7. The method of claim 1, wherein the metadata that describes the display device includes screen resolution, computing resources, location, battery life, required power, and available bandwidth.

8. The method of claim 1, further comprising:
reevaluating the selecting of the optimized transcoding resource during delivery of the content item to the display device on the media stream;
when the reevaluating determines to change the selected optimized transcoding resource to a new optimized transcoding resource,
terminating delivery of the content item to the display device on the media stream;
reserving the new optimized transcoding resource;
delivering the content item to the display device on a new media stream that utilizes the new optimized transcoding resource,
wherein the transition from the media stream to the new media stream is seamless on the display device.

9. A system for using a computer to optimize delivery of a content item from a content distribution network to a display device, wherein the content distribution network includes at least one transcoding resource, each transcoding resource converting the content item from a first format to a second format, comprising:
a memory device resident in the computer; and
a processor disposed in communication with the memory device, the processor configured to:
receive a request at the computer to deliver the content item to the display device;
obtain metadata that describes the content item;
determine a preferred technique for transcoding the content item;
determine a state of the content distribution network;
obtain a predicted behavior for a user when accessing the content item on the display device;
obtain metadata that describes the display device;
select, from said at least one transcoding resource, an optimized transcoding resource, the selection based on an evaluation of:
the metadata that describes the content item,
the preferred technique for transcoding the content item,
the state of the content distribution network,
the predicted behavior for the user, and
the metadata that describes the display device;
reserve the selected transcoding resource; and
deliver the content item to the display device on a media stream that utilizes the selected transcoding resource.

10. The system of claim 9, wherein to obtain the metadata that describes the content item, the processor is further configured to:
send a request for the metadata that describes the content item to a metadata repository; and
receive the metadata that describes the content item in response to the request for the metadata.

11. The system of claim 9, wherein to obtain the metadata that describes the content item, the processor is further configured to:
retrieve the metadata that describes the content item from tag fields embedded in the content item.

12. The system of claim 9, wherein the metadata that describes the content item includes a duration for the content item, available display formats and encodings, and popularity and topical nature of the content item.

13. The system of claim 9, wherein to determine the state, the processor is further configured to:
analyze traffic congestion and bandwidth availability for the content distribution network; and
obtain an estimated cost for transcoding the content item with each transcoding resource that is available.

14. The system of claim 9, wherein the predicted behavior for the user is based on a profile for the user, past behavior for the user, and past behavior of other users.

15. The system of claim 9, wherein the metadata that describes the display device includes screen resolution, computing resources, location, battery life, required power, and available bandwidth.

16. The system of claim 9, wherein the processor is further configured to:
reevaluate the selection of the optimized transcoding resource during delivery of the content item to the display device on the media stream;
when the reevaluation determines to change the selection of the optimized transcoding resource to a new optimized transcoding resource,
terminate delivery of the content item to the display device on the media stream;
reserve the new optimized transcoding resource;
deliver the content item to the display device on a new media stream that utilizes the new optimized transcoding resource,
wherein the transition from the media stream to the new media stream is seamless on the display device.

17. A system for using distributed computing devices to optimize delivery of a content item from a content distribution network to a display device, wherein the content distribution network includes at least one transcoding resource, each transcoding resource converting the content item from a first format to a second format, comprising:
at least one request handler in the distributed computers to:
receive a request to deliver the content item to the display device;
at least one optimizer in the distributed computers to:
obtain metadata that describes the content item;
receive a preferred technique for transcoding the content item from a rules and policy engine in the distributed computers;
receive a state of the content distribution network from a network admission control in the distributed computers;
receive a predicted behavior for a user when accessing the content item on the display device from a user behavior predictor in the distributed computers;
obtain metadata that describes the display device; and
select, from said at least one transcoding resource, an optimized transcoding resource, the selection based on an evaluation of:
the metadata that describes the content item,
the preferred technique for transcoding the content item,
the state of the content distribution network,
the predicted behavior for the user, and
the metadata that describes the display device; and
at least one workflow engine in the distributed computers to:
reserve the selected transcoding resource; and
deliver the content item to the display device on a media stream that utilizes the selected transcoding resource.

18. The system of claim 17, wherein to obtain the metadata that describes the content item, said at least one optimizer is further configured to:
send a request for the metadata that describes the content item to a metadata repository in the distributed computers; and
receive the metadata that describes the content item in response to the request for the metadata.

19. The system of claim 17, wherein to obtain the metadata that describes the content item, said at least one optimizer is further configured to:
retrieve the metadata that describes the content item from tag fields embedded in the content item.

20. The system of claim 17, wherein the metadata that describes the content item includes a duration for the content item, available display formats and encodings, and popularity and topical nature of the content item.

21. The system of claim 17, wherein to determine the state, said at least one optimizer is further configured to:
analyze traffic congestion and bandwidth availability for the content distribution network; and
obtain an estimated cost for transcoding the content item with each transcoding resource that is available.

22. The system of claim 17, wherein the predicted behavior for the user is based on a profile for the user, past behavior for the user, and past behavior of other users.

23. The system of claim 17, wherein the metadata that describes the display device includes screen resolution, computing resources, location, battery life, required power, and available bandwidth.

24. The system of claim 17, wherein said at least one optimizer is further configured to:
reevaluate the selection of the optimized transcoding resource during delivery of the content item to the display device on the media stream;
when the reevaluation determines to change the selection of the optimized transcoding resource to a new optimized transcoding resource,
terminate delivery of the content item to the display device on the media stream;
reserve the new optimized transcoding resource;
deliver the content item to the display device on a new media stream that utilizes the new optimized transcoding resource,
wherein the transition from the media stream to the new media stream is seamless on the display device.
